(19) United States
(12) Patent Application Publication
(10) Pub. No.: US 2025/0379787 A1
(43) Pub. Date: Dec. 11, 2025

(54) INFORMATION PROCESSING APPARATUS, METHOD, AND STORAGE MEDIUM

(71) Applicant: CANON KABUSHIKI KAISHA, Tokyo (JP)

(72) Inventor: SHOHEI BABA, Tokyo (JP)

(21) Appl. No.: 19/214,643

(22) Filed: May 21, 2025

(30) Foreign Application Priority Data
Jun. 5, 2024 (JP) 2024-091575

(51) Int. Cl. H04L 41/0823; H04L 67/56

(52) U.S. Cl. CPC H04L 41/0823; H04L 67/56

(57) ABSTRACT

An information processing apparatus, comprising: a proxy server for relaying communication from a network device, which is included in management targets of a management service of device management system, to an external network; one or more memories storing instructions, and one or more processors capable of executing the instructions causing the information processing apparatus to: set setting information indicating one or more conditions related to a distribution of a device setting value to the network device; executes, based on the setting information, first processing for distributing a setting value related to a proxy setting and second processing for instructing the network device to restart, wherein the distributed setting value indicates the proxy server is used for the communication from the network device to the external network.

### BACKGROUND

### Field

The present disclosure relates to an information processing apparatus, a method and a program.

### Description of the Related Art

In recent years, there is a system referred to as the Internet of Things (IoT) in which various devices are connected to a server and a cloud service via a network, and information on these devices is utilized to provide a service with high added value. Such systems are generally configured by e two main systems.

The first system is a device management system that provides a device management service, a storage service, and an authentication and authorization service. The device management service manages a connected device. The storage service manages collected device information. The authentication and authorization service includes an authentication and authorization function for securely connecting a device to a cloud service. The second system is a contract service provision system that provides each type of service such as a device maintenance service, a reporting service, a software distribution service, and the like in cooperation with the device management system.

Additionally, in the Internet of Things, there are cases in which a monitoring apparatus is used to aggregate communication between a device and a cloud service. The monitoring apparatus manages the device by periodic polling, use of a proxy server, and the like. For example, Japanese Patent Laid-Open No. 2018-136876 discloses a technology in which a monitoring apparatus enables a self-monitoring function of a device in order for the device to transmit monitoring data to a management server via a proxy server in the monitoring apparatus.

However, the system disclosed in Japanese Patent Laid-Open No. 2018-136876 does not have a function of communicating with the management server via the proxy server in the monitoring apparatus for functions other than the self-monitoring function of the device. In optional services such as a software distribution service and the like, it is common to enable functions by having a service engineer set them from the service mode menu of the device. In such a case, since a service engineer needs to perform the settings from the service mode menu for each device, the operational burden on the service engineer increases.

Therefore, the present disclosure provides an information processing apparatus, a method, and a program that enable the reduction of the operational burden of a service engineer.

### SUMMARY

An information processing apparatus, comprising: a proxy server for relaying communication from a network device, which is included in management targets of a management service of device management system, to an external network; one or more memories storing instructions, and one or more processors capable of executing the instructions causing the information processing apparatus to: set setting information indicating one or more conditions related to a distribution of a device setting value to the network device; executes, based on the setting information, first processing for distributing a setting value related to a proxy setting and second processing for instructing the network device to restart, wherein the distributed setting value indicates the proxy server is used for the communication from the network device to the external network.

According to the present disclosure, an information processing apparatus, a method, and a program capable of reducing the operational burden on a service engineer are provided.

Further features of the present disclosure will become apparent from the following description of exemplary embodiments with reference to the attached drawings.

### BRIEF DESCRIPTION OF THE DRAWINGS

FIG. 1 is a diagram illustrating an example of the entire system according to the first embodiment.

FIG. 2 is a block diagram illustrating an example of an internal configuration of a device according to the first embodiment.

FIG. 3 is a block diagram illustrating examples of the internal configurations of each type of server and a monitoring device according to the first embodiment.

FIG. 4 is a block diagram illustrating an example of a functional configuration of a device according to the first embodiment.

FIG. 5 is a block diagram illustrating an example of a functional configuration of the monitoring device according to the first embodiment.

FIG. 6 is a diagram illustrating an example of a device information table that is managed by the monitoring apparatus according to the first embodiment.

FIG. 7 is a diagram illustrating an example of a setting value distribution function management information table managed by the monitoring apparatus according to the first embodiment.

FIG. 8 is a sequence diagram illustrating an example of the service mode setting value distribution processing according to the first embodiment.

FIG. 9A is a flowchart illustrating an example of the service mode setting value distribution processing performed by the monitoring device according to the first embodiment.

FIG. 9B is a flowchart illustrating an example of the service mode setting value distribution processing executed by the monitoring device according to the first embodiment.

FIG. 10 is a diagram illustrating an example of a setting value distribution function setting screen according to the first embodiment.

FIG. 11 is a flowchart illustrating an example of immediate service mode setting value distribution processing executed by the monitoring apparatus according to the second embodiment.

FIG. 12 is a diagram illustrating an example of a management target device list screen according to the second embodiment.

FIG. 13 is a diagram illustrating an example of a detailed information screen for a device according to the second embodiment.

### DESCRIPTION OF THE EMBODIMENTS

Hereinafter, embodiments of the present disclosure will be explained with reference to the drawings.

### First Embodiment

### <System Configuration>

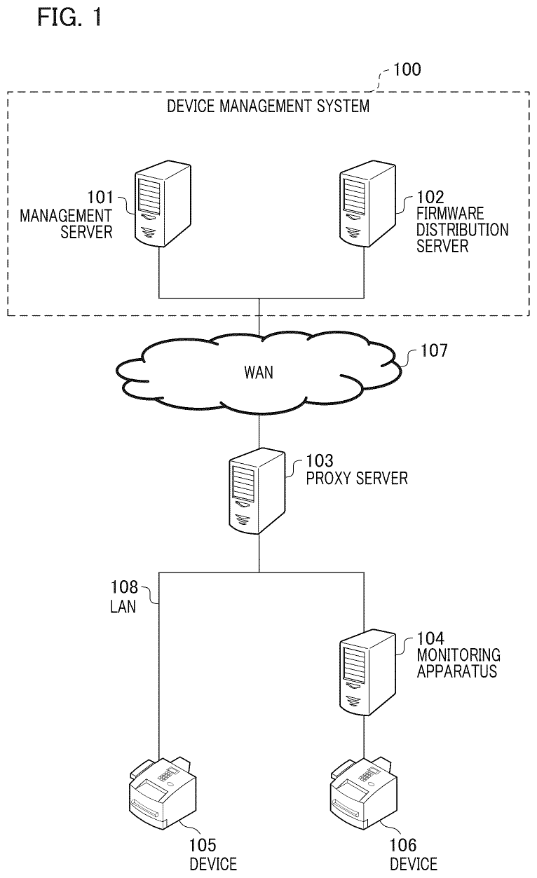

FIG. 1 is a diagram illustrating an example of the entire system according to the first embodiment. A device management system 100 is a system for managing network devices via a network and includes a management server 101 and a firmware distribution server 102. For example, the device management system 100 manages the device 105 and the device 106 via a wide area network (WAN) 107 and a local area network (LAN) 108.

A proxy server 103 is connected between the device management system 100 and the device 105. In addition to the proxy server 103, a monitoring apparatus 104, which functions as a proxy server, is connected between the device management system 100 and the device 106.

The management server 101 communicates with the device 105 and the device 106, acquires monitoring data and a state of the devices, and distributes a setting value. The firmware distribution server 102 provides a software distribution service that manages and distributes software such as firmware, an extended application, and the like of the device 105 and the device 106. Although in the first embodiment, a case in which the firmware distribution server 102 provides a software distribution service will be explained as an example, a service other than the software distribution service may also be provided by the firmware distribution server 102.

The proxy server 103 is a proxy server for protecting an intra-company environment. The monitoring apparatus 104 is an example of an information processing apparatus, and aggregates communication between the device 106 and the device management system 100. The monitoring apparatus 104 includes the device management system 100 that manages a network device to which one or more cloud services can be provided, and a proxy server that can relay communication with the network device. The device 105 and the device 106 are examples of network devices and receive the provision of each type of service from the device management system 100. In the first embodiment, a case in which the device 105 and the device 106 are image processing apparatuses will be explained as an example.

### <Internal Configuration of Image Forming Apparatus>

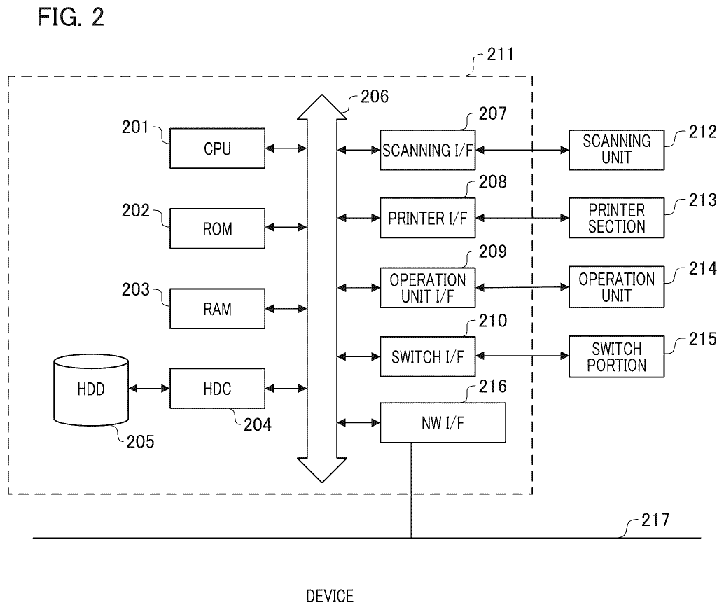

FIG. 2 is a block diagram illustrating an example of an internal configuration of a device according to the first embodiment. A central processing unit (CPU) 201 is stored in a read only memory (ROM) 202 or a hard disk drive (HDD) 205, executes software that controls the entire image forming apparatus, and comprehensively controls each piece of hardware connected to a system bus 206. A RAM (Random Access Memory) 203 functions as a work area and the like of the CPU 201. A hard disk controller (HDC) 204 controls the HDD 205.

A scanning I/F 207 is connected to a scanning unit 212 and controls the scanning unit 212. A printer I/F 208 is connected to a printer section 213 and controls the printer section 213. An operation unit I/F 209 is connected to an operation unit 214 and executes processing for performing a display on the operation unit 214, processing for receiving inputs using the operation unit 214, and the like.

The operation unit 214 is a button for operating the device, a display device, a liquid crystal display screen with a touch panel input, or a combination thereof. The operation unit 214 displays information from the overall control unit 211 to the user, and notifies the overall control unit 211 of an instruction that has been input by the user A switch I/F 210 is connected to a switch portion 215 and controls operations from the switch portion 215. The switch portion 215 is a switch and the like for operating the device. For example, the switch portion 215 is a switch that controls the on/off state of the power supply of the overall control unit 211.

A network interface card (NIC) 216 executes the transmission and reception of data to and from an external apparatus such as a host computer and the like via a network 217. In this context, the portion that is surrounded by a broken line in FIG. 2 will be referred to as the overall control unit 211. The overall control unit 211 controls each type of device and the interfaces that have been connected to the image forming apparatus and controls the operation of the entire image forming apparatus.

The scanning unit 212 scans an image of a document, outputs image data corresponding to the image of the document to the printer section 213 based on an instruction from the user, and stores the image data in a storage device of the image forming apparatus. The scanning unit 212 can also transmit image data to a host computer that is connected to the network 217 via the network I/F 216.

The printer section 213 prints documents that have been read by the scanning unit 212, image data stored in the HDD 205 in the main body of the image forming apparatus, and the like. The printer section 213 also receives print jobs from a host computer that is connected to the network 217 via the network I/F 216, and prints these print jobs. The network I/F 216 is connected via the network 217, and is used by the overall control unit 211 to communicate with other information devices on the network 217.

### <Internal Configuration of Each Type of Server and the Monitoring Device>

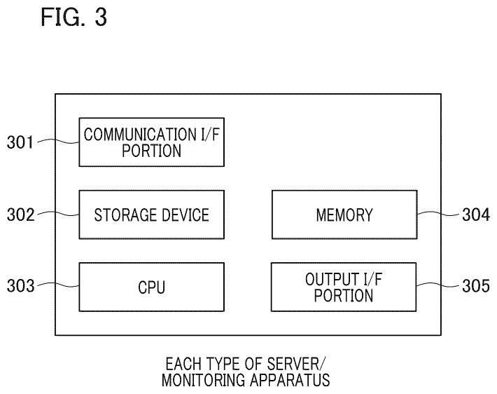

FIG. 3 is a block diagram illustrating an example of the internal configurations of each type of server and the monitoring device according to the first embodiment. Specifically, FIG. 3 illustrates an example of the internal configuration of the management server 101, the firmware distribution server 102, the proxy server 103, and the monitoring apparatus 104.

A communication I/F portion 301 is a network interface for communicating with an external system, a device, and other components. A storage device 302 stores an operating system (OS), programs, management data, data collected from external systems, devices, and the like. A CPU 303 loads programs from the storage device 302 onto a memory 304 and executes the programs. An output I/F portion 305 is connected to an output device such as a display and the like, and outputs execution results of programs and the like.

### <Functional Configuration of the Devices>

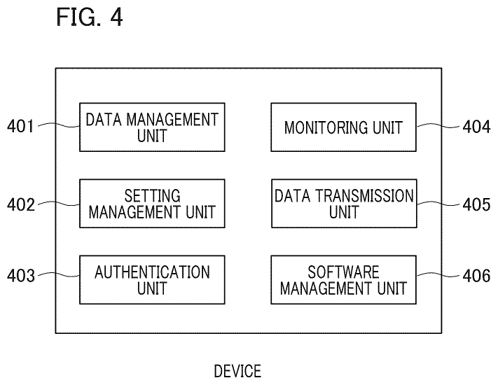

FIG. 4 is a block diagram illustrating an example of a functional configuration of a device according to the first embodiment. Specifically, FIG. 4 illustrates an example of a functional configuration of the device 105 and the device 106.

A data management unit 401 manages basic information, each type of operation information, and the like of the device. A setting management unit 402 manages a service mode setting value of the device 105 and a service mode setting value of the device 106. These service mode setting values are, for example, values related to proxy settings that are used by a software management unit 406. An authentication unit 403 sends authentication requests to the management server 101 and manages authentication information necessary for communication with the management server 101. A monitoring unit 404 collects monitoring data required for monitoring the device status. A data transmission unit 405 transmits the monitoring data to the management server 101. The software management unit 406 acquires and manages firmware, software, and the like that has been distributed from the firmware distribution server 102, and installs the firmware, the software, and the like.

### <Functional Configuration of the Monitoring Apparatus>

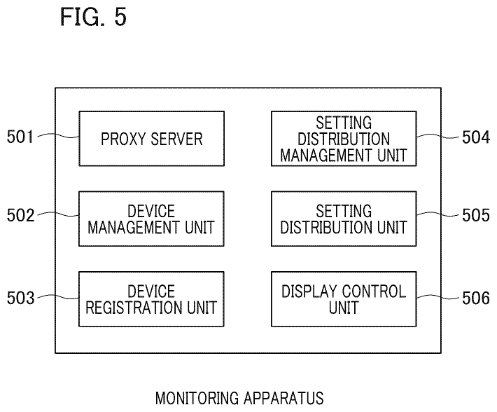

FIG. 5 is a block diagram illustrating an example of a functional configuration of the monitoring device according to the first embodiment. A proxy server 501 aggregates communication from the device 106 and relays communication between the monitoring apparatus 104 and the device management system 100. A device management unit 502 manages a device setting value of the device 106. The device setting value includes, for example, a value for identifying the device, a value indicating a method of monitoring the device, a value indicating whether or not the device has been registered in the device management service, and a service mode setting value of the device. Additionally, the device management service is provided by the device management system 100. The device setting value is managed by a device information table in the storage device 302.

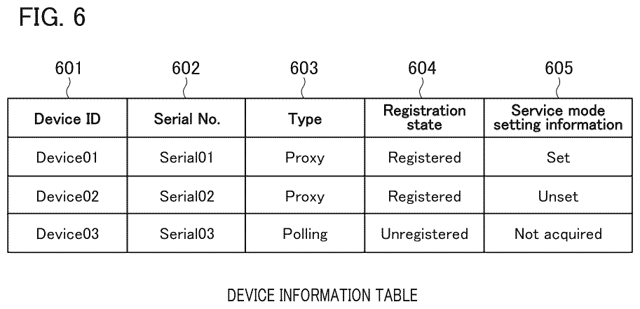

FIG. 6 is a diagram illustrating an example of a device information table managed by the monitoring apparatus according to the first embodiment. Device ID 601 is a value for uniquely identifying the device within the system. Serial No. 602 is a value for uniquely identifying the device. Type 603 is a value that indicates the monitoring method of the device, and it stores either the value “Proxy,” which indicates the proxy mode, or the value “Polling,” which indicates the polling mode.

Registration state 604 is a value indicating whether or not the device has been registered as a device that is a target of the device management service provided by the device management system 100. This value is either a value “registered”, which indicates that the device has been registered, or a value “unregistered” which indicates that the device has not been registered.

Service mode setting information 605 is a value that indicates whether or not the monitoring apparatus 104 needs to distribute a service mode setting value to the device 106. The service mode setting value that becomes the target is a setting value for the optional function of the network device to execute communication via the proxy server 501. For example, the service mode setting value that becomes the target in this context is a setting value related to a proxy setting used by the software management unit 406 of the device 106.

Here, the explanation will return to FIG. 5. A device registration unit 503 instructs the device 106 to register the device 106 as a target device of the device management service provided by the device management system 100. Additionally, the device registration unit 503 acquires capability information of the device 106 to determine whether or not to provide a registration instruction to the device 106.

A setting distribution management unit 504 is an example of a management unit, and manages distribution function information that is setting information for a service mode setting value distribution function. The distribution function information includes, for example, on/off setting information of the service mode setting value distribution function, that is, information indicating whether or not the function of distributing the service mode setting value to the network device is enabled. Additionally, the distribution function information includes schedule information for the case of distribution. These pieces of information are set in a display control unit 506, which will be described below, and are managed by a setting value distribution function management information table in the storage device 302 that is included in the monitoring apparatus 104. Furthermore, the management unit manages setting information that specifies the time zone during which the device setting values can be distributed to the network device.

Additionally, the setting distribution management unit 504 is an example of a processing unit. The processing unit executes the following processing in a case in which it is necessary to distribute a target service mode setting value for communication with the device management system via the proxy server to the network device. That is, in such a case, the processing unit executes processing to distribute the service mode setting value and processing to instruct the network device to restart based on the setting information.

The processing unit determines whether or not it is necessary to distribute the service mode setting value by acquiring the information on the service mode setting that has already been set in the network device from this network device.

Additionally, in a case in which the function of distributing the service mode setting value is enabled and the current time is within the time zone indicated by the setting information, the distribution unit executes a processing to distribute the service mode setting value and processing to instruct the network device to restart.

Additionally, the monitoring apparatus 104 includes a provision unit that provides a screen that enables the execution of processing for distributing the service mode setting value and processing for instructing the network device to restart, regardless of the setting information.

Note that details of the processing performed by the above-described setting distribution unit will be described below.

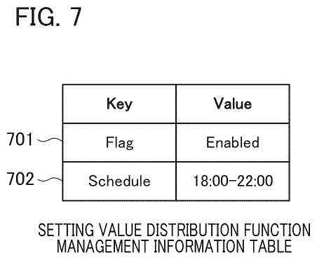

FIG. 7 is a diagram illustrating an example of a setting value distribution function management information table that is managed by the monitoring apparatus according to the first embodiment. As illustrated in FIG. 7, the setting value distribution function management information table is configured by setting items (Key) and setting values (Value). Flag 701 is a value that indicates whether or not the service mode setting value distribution function is enabled. Schedule 702 is a value that indicates the time zone during which the service mode setting values can be distributed in a case in which the function of distributing the service mode setting value is enabled, and it is also referred to as setting information. In general, in a case in which the service mode setting value is updated, the device is restarted, and thus the monitoring apparatus 104 manages a time zone during which the service mode setting value can be distributed, which is designated by the user.

Here, the explanation will return to FIG. 5. A setting value distribution unit 505 distributes the service mode setting value to the device 106. The setting value distribution unit 505 manages the service mode setting value to be distributed in the storage device 302 in advance. The display control unit 506 controls display in the output I/F portion 305.

### <Overall Sequence of the Service Mode Setting Value Distribution Processing>

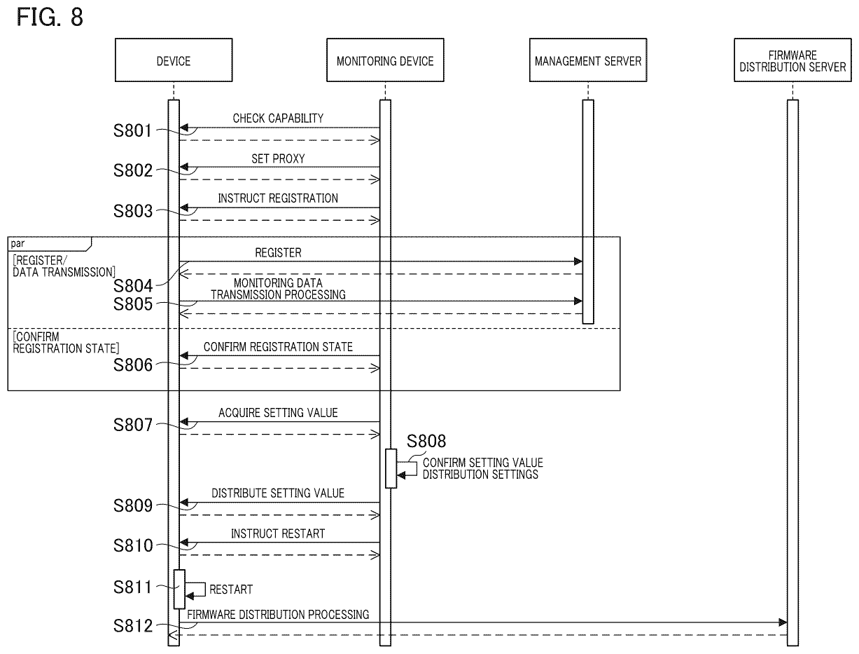

FIG. 8 is a sequence diagram illustrating an example of the service mode setting value distribution processing according to the first embodiment.

In step S801, the monitoring apparatus 104 acquires monitoring capability information regarding the device 106, and confirms whether or not the device can be monitored in the proxy mode. In a case in which the monitoring apparatus 104 has determined that the device can be monitored in the proxy mode, the processing proceeds to step S802. Note that in a case in which the monitoring apparatus 104 determines that the device cannot be monitored in the proxy mode, the process directly related to the first embodiment is not executed, and thus the explanation thereof will be omitted.

In step S802, the monitoring apparatus 104 sets information regarding the proxy server 501 for the device 106. By this setting, the device 106 can execute communication in the registration processing for the management server 101 and communication in the monitoring data transmission processing via the proxy server 501 in the monitoring apparatus 104.

In step S803, the monitoring apparatus 104 sends a device registration instruction to the device 106.

In step S804, the device 106 executes the registration processing for the management server 101. During this time, the device 106 executes communication via the proxy server 501 of the monitoring apparatus 104 that was set in step S802.

In step S805, the device 106 starts monitoring-data transmission processing to the management server 101. During this time, the device 106 executes communication via the proxy server 501 of the monitoring apparatus 104 that was set in step S802.

In step S806, the monitoring apparatus 104 acquires a device-registration state from the device 106 a predetermined number of times and at predetermined retry intervals, and confirms the completion of the device-registration processing in step S804.

In step S807, the monitoring apparatus 104 acquires a service mode setting value from the device 106. The service mode setting value acquired here is proxy setting information that is used when the device 106 uses the firmware distribution function. In a case in which the proxy setting information is a proxy server setting of the main body of the device 106, that is, a setting for using the proxy server 103, the monitoring apparatus 104 advances the processing to step S808. In contrast, in a case in which the proxy setting information is a setting for using the proxy server 501 of the monitoring apparatus 104, the monitoring apparatus 104 ends the process.

In step S808, the monitoring apparatus 104 confirms the setting of the service mode setting value distribution function that is held in the monitoring apparatus 104. In a case in which the monitoring apparatus 104 confirms that the service mode setting value distribution function is enabled and the current time is within the time zone during which the service mode setting values can be distributed, the processing proceeds to step S809. In contrast, in a case in which the monitoring apparatus 104 confirms that the service mode setting value distribution function is disabled, or in a case in which the monitoring apparatus 1014 confirms that the current time is not within the time zone during which the service mode setting values can be distributed even if the service mode setting value distribution function is enabled, the processing is completed.

In step S809, when the device 106 uses the firmware distribution function, the monitoring apparatus 104 distributes the setting value for using the proxy server 501 of the monitoring apparatus 104 to the device 106.

In step S810, the monitoring apparatus 104 sends a restart instruction to the device 106 to reflect the service mode setting value that was distributed in step S809.

In step S811, the device 106 executes restart processing.

In step S812, the device 106 executes the processing for firmware distribution via the proxy server 501 of the monitoring apparatus 104.

### <Service Mode Setting Value Distribution Processing in the Monitoring Apparatus>

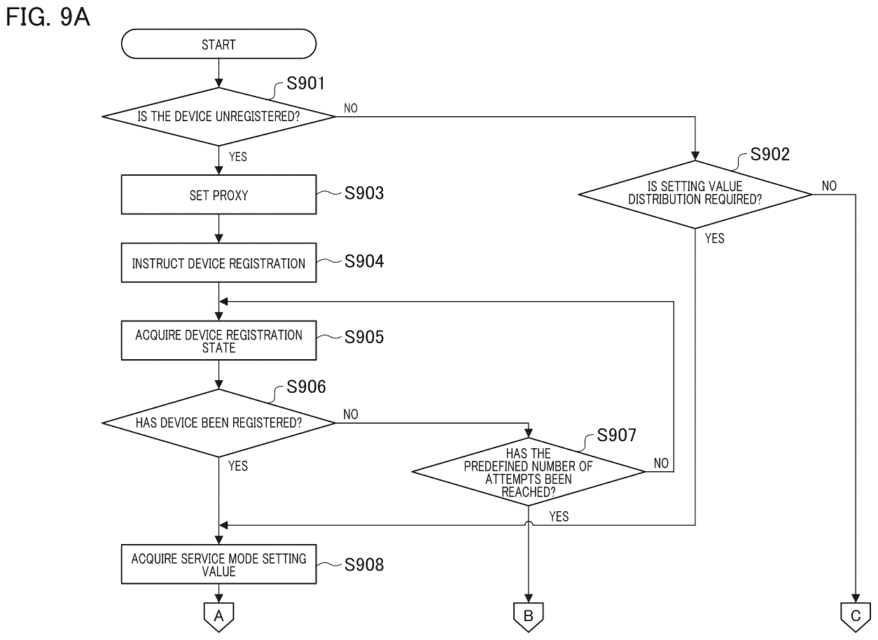

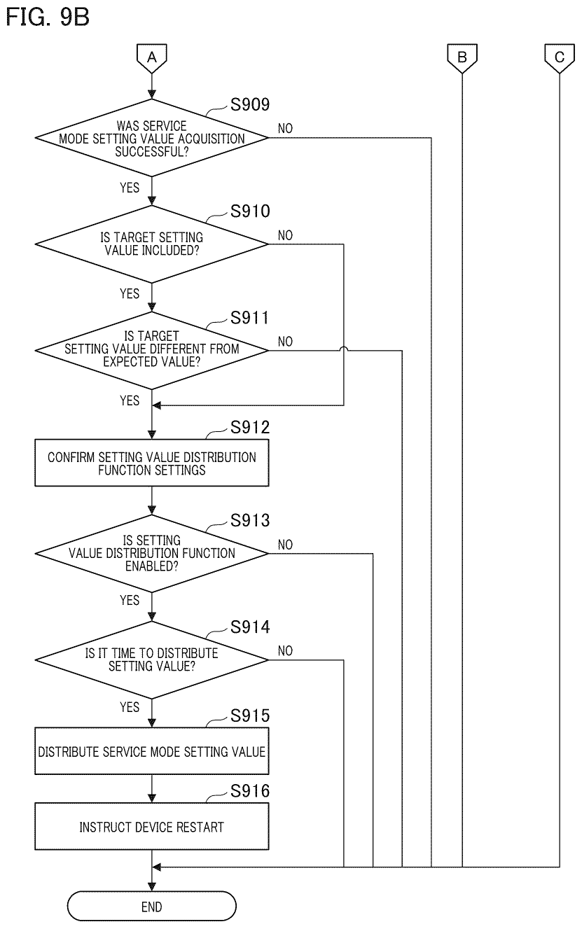

FIG. 9A and FIG. 9B are flowcharts illustrating an example of service mode setting value distribution processing executed by the monitoring device according to the first embodiment. The processing that is shown in FIG. 9A and FIG. 9B is executed periodically, for example, once a day, and the like for all devices that can be monitored in the proxy mode. Additionally, the processing that iss shown in FIG. 9A and FIG. 9B may also be executed when there is an instruction from the user, in addition to the periodical execution.

In step S901, the device management unit 502 confirms whether or not the device has been registered in the management server 101. Specifically, the device management unit 502 confirms whether or not the device has been registered on the management server 101 based on the information on the registration state that is stored in the device information table. In a case in which the device management unit 502 confirms that the device has not been registered in the management server 101, it advances the processing to step S903. In contrast, in a case in which the device management unit 502 confirms that the device has been registered on the management server 101, it advances the processing to step S902.

In step S902, the device management unit 502 confirms whether or not service mode setting value distribution is necessary for the device. Specifically, the device management unit 502 confirms whether or not the service mode setting value distribution is necessary for the device based on the service mode setting value stored in the device information table. In a case in which the service mode setting value is not acquired or in a case in which the service mode setting value is not set, the device management unit 502 advances the processing to step S908. In contrast, in a case in which the service mode setting value has been set, the device management unit 502 ends the processing.

In step S903, the device registration unit 503 sets the setting information of the proxy server 501 in the monitoring apparatus 104 to the device. The setting information of the proxy server 501 includes address, port information, and authentication information of the proxy server 501.

In step S904, the device registration unit 503 provides a device registration instruction to the device. Upon receiving the device registration instruction, the device executes the registration process for the management server 101.

In step S905, the device registration unit 503 acquires a device registration state for the device.

In step S906, the device registration unit 503 confirms whether or not the device registration state is registered. Specifically, in a case in which the device registration unit 503 confirms that the device registration state that was acquired in step S905 is registered, it advances the processing to step S908. In contrast, in a case which the device registration unit 503 confirms that the device registration state is unregistered, it advances the processing to step S907.

In step S907, the device registration unit 503 confirms whether or not the number of times that the processing for step S905 has been executed has reached a predetermined number of attempts. Specifically, in step S907, when executing the processing for step S905, the device registration unit 503, manages the number of executions by incrementing the number of executions (the initial value is 0) held in the memory 304 by one, and confirms whether or not the number of executions has reached the predetermined number of attempts held in advance in the memory 304. In a case in which the device registration unit 503 confirms that the number of times that the processing for step S905 has been executed has reached the predetermined number of attempts, the processing is completed. In contrast, in a case in which the device registration unit 503 confirms that the number of times that the processing for step S905 has been executed has not reached the predetermined number of attempts, it advances the processing to step S905.

In step S908, the setting value distribution unit 505 acquires a service mode setting value for the device.

In step S909, the setting value distribution unit 505 confirms whether or not the service mode setting value has been acquired. Specifically, in step S908, the setting value distribution unit 505 receives a return of a success response and confirms whether or not the service mode setting value has been successfully acquired depending on whether or not the service mode setting value is included therein. In a case in which the setting value distribution unit 505 confirms that the service mode setting value has been successfully acquired, it advances the processing to step S910. In contrast, in a case in which the setting value distribution unit 505 confirms that the service mode setting value was not successfully acquired, it ends the processing. The service mode setting value acquired here is made a value that may be acquired in an XML (Extensible Markup Language) format. Note that the service mode setting value acquired here may also be in another format such as a JavaScript Object Notation (JSON) format, and the like instead of the XML format.

In step S910, the setting value distribution unit 505 confirms whether or not the service mode setting value information that was acquired in the processing for step S909 includes a service mode setting value that is a target of the service mode setting value distribution function.

The service mode setting value that is a target of the service mode setting value distribution function refers to proxy setting information that is used by the software management unit 406 of the device 106. For example, the information is defined by <FW-PRX> as the XML tag attribute to be acquired, and is represented by the value “0” or “1”. “0” indicates that the proxy setting of the main body of the device 106 is used. In general, information for the proxy server 103 is set in the proxy settings of the main body of the device 106. In contrast, “1” indicates that the setting of the proxy server 501 of the monitoring apparatus 104 that was set in the processing for step S903 is used.

The setting value distribution unit 505 confirms whether or not the attribute of <FW-PRX> is included in the service mode setting value that ahs been acquired. In a case in which the setting value distribution unit 505 confirms that the attribute of <FW-PRX> is included in the acquired service mode setting value, it advances the processing to step S911. In contrast, in a case in which the setting value distribution unit 505 confirms that the attribute of <FW-PRX> is not included in the acquired service mode setting value, it advances the processing to step S912.

In step S911, the setting value distribution unit 505 confirms whether or not the value of the <FW-PRX> attribute is “0”. In a case in which the setting value distribution unit 505 confirms that the value of the <FW-PRX> attribute is “0”, it advances the processing to step S912. In a case in which the setting value distribution unit 505 confirms that the value of the <FW-PRX> attribute is “1”, it determines that the setting distribution is unnecessary and ends the processing.

In step S912, the setting distribution management unit 504 confirms the information for the Flag 701 and the Schedule702, which is stored in the setting value distribution management information table. These pieces of information are set from the setting value distribution function setting screen.

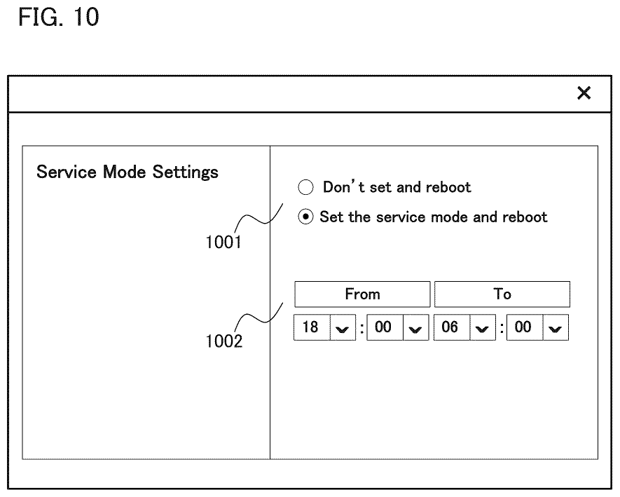

FIG. 10 is a diagram illustrating an example of a setting value distribution function setting screen according to the first embodiment. The radio button 1001 is used to select whether or not to distribute the service mode setting value from the monitoring apparatus 104 to the device. The information for the Flag 701 of the setting value distribution function management information table is set based on this setting. The input block 1002 is used to cause the monitoring apparatus 104 to designate a time zone for distributing the service mode setting value to the device. The information for the Schedule702 of the setting value distribution function management information table is set based on this setting.

In step S913, the setting distribution management unit 504 confirms whether or not the value for the Flag 701 that is stored in the setting value distribution management information table is enabled. In a case in which the setting distribution management unit 504 confirms that the value for the Flag 701 that is stored in the setting value distribution function management information table is enabled, it advances the processing to step S914. In contrast, in a case in which the setting distribution management unit 504 confirms that the value for the Flag701 that is stored in the setting value distribution management information table is disabled, it ends the processing.

In step S914, the setting distribution management unit 504 confirms whether or not the current time falls within the value for the Schedule702 that is stored in the setting value distribution function management information table, in other words, the time zone during which the setting values can be distributed. In a case in which the setting distribution management unit 504 confirms that the current time is within the time zone during which the setting values can be distributed, the setting distribution management unit 504 advances the processing to step S915. In contrast, in a case in which the setting distribution management unit 504 confirms that the current time is not within the time zone during which the setting values can be distributed, it ends the processing.

In step S915, the setting value distribution unit 505 distributes the service mode setting value to the device. The service mode setting value distributed here is a setting value for using the proxy server 501 of the monitoring apparatus 104 when the device uses the firmware distribution function. Specifically, the service mode setting value distributed here is a service mode setting value in which the value of the <FW-PRX> attribute is set to “1”.

In step 916, the setting distribution unit 505 sends a restart instruction to the device. The service mode setting value is reflected by the device being restarted.

As explained above, in the first embodiment, the monitoring apparatus 104 can also aggregate communication for optional functions other than the monitoring data transmission function of the device 106 via the proxy server 501 by distributing the service mode setting value. It is thereby possible to reduce the operational burden on the service engineer.

### Second Embodiment

In the first embodiment, in the service mode setting value distribution processing that is periodically performed, even in a case in which the distribution of the service mode setting value is necessary, the distribution of the service mode setting value was not executed outside of the time zone designated by the user. However, there may be cases in which the distribution of the service mode setting value needs to be executed individually for a specific device even during a time zone that is not the time zone that was designated by the user. In the second embodiment, it is possible to execute the distribution of the service mode setting value individually for each device at any timing designated by the user for devices that require the distribution of the service mode setting value. In the second embodiment, only differences from the first embodiment will be explained, and the same configurations and processes as those of the first embodiment will be denoted by the same reference numerals, and the explanation thereof will be omitted.

### <Immediate Service Mode Setting Value Distribution Processing in the Monitoring Apparatus>

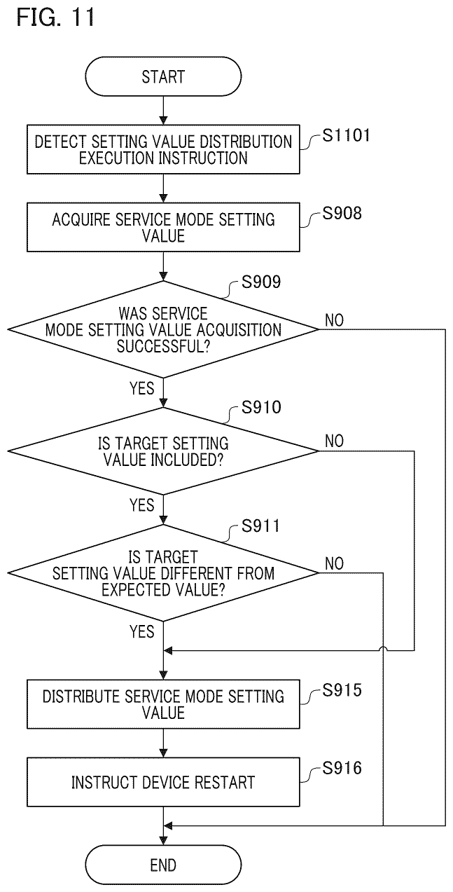

FIG. 11 is a flowchart illustrating an example of immediate service mode setting value distribution processing performed by the monitoring device according to the second embodiment.

In step S1101, the display control unit 506 displays management target device list screen and a detailed information screen for these devices according to an operation from the user and receives a service mode setting value distribution instruction from the user.

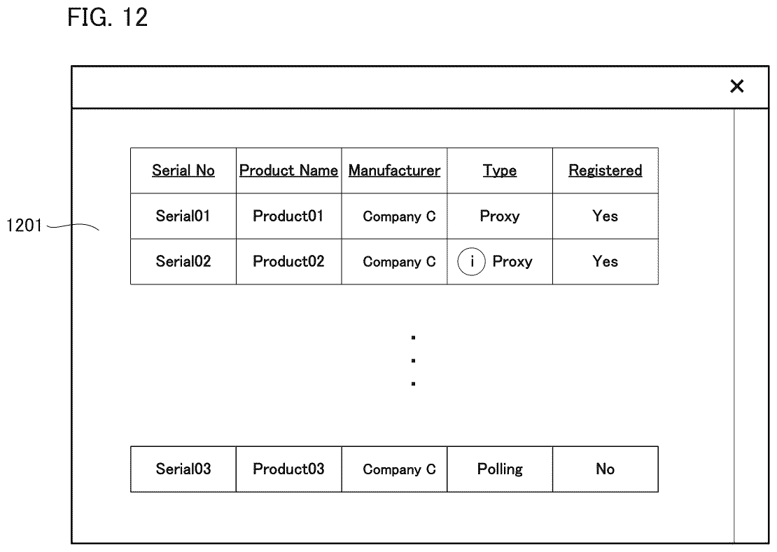

FIG. 12 is a diagram showing an example of a management target device list screen in the second embodiment. The list information 1201 shows a list of management target devices. In this context, as the attribute information of the device, a Serial No. (serial number), Product Name (product name), Manufacturer (manufacturer name), Type (monitoring mode), and Registered (registration state) are displayed.

At this time, as the information for the Type attribute, an information mark is also displayed for a device for which it has been determined that the service mode setting value needs to be distributed. Specifically, based on the service mode setting value stored in the device information table, the information mark is displayed for the devices for which the service mode setting value has not been acquired and the devices for which the service mode setting value has not been set. As a result, it is possible to easily identify the devices to which the service mode setting value should be distributed. Note that on the management target device list screen, information such as an Internet Protocol (IP) address, a Media Access Control (MAC) address, and the like that have been set in the device may also be further displayed.

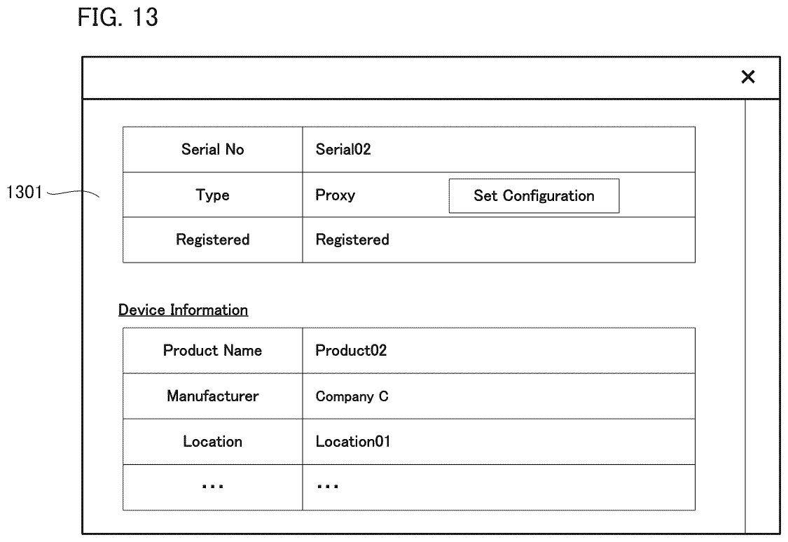

FIG. 13 is a diagram illustrating an example of a detailed information screen for a device according to the second embodiment. The screen shown in FIG. 13 can be displayed by clicking the attribute information of any target device on the management target device list screen.

The information 1301 shows a list of detailed information for the devices. Here, in addition to the attribute information of the devices displayed on the management target device list screen, more detailed information is displayed. The more detailed information is, for example, information indicating a Location (installation location). At this time, a Set Configuration button is also displayed next to the value for the Type attribute. Specifically, based on the service mode setting value stored in the device information table, the Set Configuration button is displayed for devices for which a service mode setting value has not been acquired or devices for which a service mode setting value has not been set. When the button is pressed down, the user can distribute the service mode setting value to the device regardless of the contents that have been set on the setting value distribution function setting screen.

As explained above, according to the second embodiment, the service mode setting value can be distributed to each device at a timing desired by the user.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions. This application claims the benefit of Japanese Patent Application No. 2024-91575, filed Jun. 5, 2024, which is hereby incorporated by reference wherein in its entirety.

What is claimed is:

1. An information processing apparatus, comprising:
a proxy server for relaying communication from a network device, which is included in management targets of a management service of device management system, to an external network;
one or more memories storing instructions, and
one or more processors capable of executing the instructions causing the information processing apparatus to:
set setting information indicating one or more conditions related to a distribution of a device setting value to the network device;
executes, based on the setting information, first processing for distributing a setting value related to a proxy setting and second processing for instructing the network device to restart,
wherein the distributed setting value indicates the proxy server is used for the communication from the network device to the external network.

2. The information processing apparatus according to claim 1, wherein the setting information includes a time zone during which the device setting value can be distributed to the network device.

3. The information processing apparatus according to claim 1, wherein the distributed setting value is a setting value for an optional function of the network device to execute the communication via the proxy server.

4. The information processing apparatus according to claim 1, wherein the first processing is executed according to a determination based on information that has already been set as service mode setting in the network device and acquired from the network device.

5. The information processing apparatus according to claim 1, wherein the instructions further cause the information processing apparatus to:
provide an instruction screen that enables the execution of the first processing and the second processing, regardless of the setting information.

6. The information processing apparatus according to claim 1, wherein the instructions further cause the information processing apparatus to provide a display to identify a network device for which the setting value according to the distribution by the first processing based on the setting information have not yet been set.

7. A method for an information processing apparatus including a proxy server for relaying communication from a network device, which is included in management targets of a management service of device management system, to an external network, the method comprising:
setting setting information indicating one or more conditions related to a distribution of a device setting value to the network device;
executing, based on the setting information, first processing for distributing a setting value related to a proxy setting and second processing for instructing the network device to restart,
wherein the distributed setting value indicates the proxy server is used for the communication from the network device to the external network.

8. A non-transitory computer-readable storage medium on which is stored a computer program for making a computer execute a method for an information processing apparatus including a proxy server for relaying communication from a network device, which is included in management targets of a management service of device management system, to an external network, the method comprising:
setting setting information indicating one or more conditions related to a distribution of a device setting value to the network device;
executing, based on the setting information, first processing for distributing a setting value related to a proxy setting and second processing for instructing the network device to restart,
wherein the distributed setting value indicates the proxy server is used for the communication from the network device to the external network.
